(19) United States
(12) Patent Application Publication
(10) Pub. No.: US 2026/0141554 A1
(43) Pub. Date: May 21, 2026

(54) INFORMATION PROCESSING APPARATUS, INFORMATION PROCESSING METHOD, AND PROGRAM

(71) Applicant: Sony Group Corporation, Tokyo (JP)

(72) Inventors: Yu NISHIMURA, Tokyo (JP); Rui KOUNO, Kanagawa (JP)

(73) Assignee: Sony Group Corporation, Tokyo (JP)

(21) Appl. No.: 19/119,771

(22) PCT Filed: Sep. 14, 2023
(86) PCT No.: PCT/JP2023/033544

§ 371 Date: Apr. 10, 2025

(30) Foreign Application Priority Data
Nov. 14, 2022 (JP) 2022-181705

(51) Int. Cl. G06T 7/73; G06T 5/50; G06V 10/74

(52) U.S. Cl. CPC G06T 7/73; G06T 5/50; G06V 10/761; G06T 2207/20044; G06T 2207/20221

(57) ABSTRACT

There is provided an information processing apparatus including circuitry configured to acquire model data, acquire, based on a position and a posture of a user, data of a pose of the user, estimate skeleton data including position information regarding portions of the user based on the position data and output a result of pose similarity based on the model data and the skeleton data, a same result of pose similarity being output based on different skeleton data that is estimated based on respective different position data of the pose of the user, the respective different position data being acquired from a first position and a first posture of the user, and from a second position and a second posture of the user, and at least one of the first position being different than the second position or the first posture is different than the second posture.

### CROSS REFERENCE TO RELATED APPLICATIONS

This application claims the benefit of Japanese Priority Patent Application JP 2022-181705 filed on Nov. 14, 2022, the entire contents of which are incorporated herein by reference.

### TECHNICAL FIELD

The present disclosure relates to an information processing apparatus, an information processing method, and a program.

### BACKGROUND ART

In recent years, a technique of calculating a degree of similarity between a pose of a user and a pose of another user (for example, a model user) and performing feedback to the user has been developed. For example, PTL 1 discloses a technique of calculating a degree of similarity of poses of respective users included in a video using a discrimination model for discriminating a degree of similarity of poses obtained by machine learning.

### CITATION LIST

### Patent Literature

PTL 1: JP 2022-532772 A

### SUMMARY

### Technical Problem

However, in the technique described in PTL 1, it is necessary to learn data in advance, and it is difficult to apply the technique to an arbitrary motion video. Moreover, since a discriminant model by a neural network is used, an arithmetic load is large, and processing in real time may be difficult.

Accordingly, the present disclosure proposes a new and improved information processing apparatus, information processing method, and program capable of reducing arithmetic load related to calculation of pose similarity.

### Solution to Problem

According to an aspect of the present disclosure, there is provided an information processing apparatus including: circuitry configured to: acquire model data; acquire, based on a position and a posture of a user, data of a pose of the user; estimate skeleton data including position information regarding portions of the user based on the position data; and output a result of pose similarity based on the model data and the skeleton data, a same result of pose similarity being output based on different skeleton data that is estimated based on respective different position data of the pose of the user, the respective different position data being acquired from a first position and a first posture of the user, and from a second position and a second posture of the user, and at least one of the first position being different than the second position or the first posture is different than the second posture.

Further, according to another aspect of the present disclosure there is provided an information processing method including: acquiring model data; acquiring, based on a position and a posture of a user, data of a pose of the user; estimating skeleton data including position information regarding portions of the user based on the position data; and outputting a result of pose similarity based on the model data and the skeleton data, a same result of pose similarity being output based on different skeleton data that is estimated based on respective different position data of the pose of the user, the respective different position data being acquired from a first position and a first posture of the user, and from a second position and a second posture of the user, and at least one of the first position being different than the second position or the first posture is different than the second posture.

Further, according to another aspect of the present disclosure there is provided a non-transitory computer-readable medium having embodied thereon a program, which when executed by a computer causes the computer to function as execute an information processing method, the method including: acquiring model data; acquiring, based on a position and a posture of a user, data of a pose of the user; estimating skeleton data including position information regarding portions of the user based on the position data; and outputting a result of pose similarity based on the model data and the skeleton data, a same result of pose similarity being output based on different skeleton data that is estimated based on respective different position data of the pose of the user, the respective different position data being acquired from a first position and a first posture of the user, and from a second position and a second posture of the user, and
at least one of the first position being different than the second position or the first posture is different than the second posture.

### BRIEF DESCRIPTION OF DRAWINGS

FIG. 1 is an explanatory diagram illustrating an information processing system according to an embodiment of the present disclosure.

FIG. 2 is an explanatory diagram illustrating an example of a functional configuration of an information processing apparatus 10 according to an embodiment of the present disclosure.

FIG. 3 is an explanatory diagram for describing a specific example related to estimation of skeleton data.

FIG. 4A is an explanatory diagram for describing a specific example of a moment feature amount according to an embodiment of the present disclosure.

FIG. 4B is an explanatory diagram for describing the specific example of the moment feature amount according to an embodiment of the present disclosure.

FIG. 5 is an explanatory diagram for describing an example of similarity scores when the position or posture of the same camera 5 is different.

FIG. 6 is an explanatory diagram for describing an example of a factor that can reduce estimation accuracy of skeleton data.

FIG. 7 is an explanatory diagram for describing a specific example related to calculation of a moment feature amount based on reliability score.

FIG. 8 is an explanatory diagram for describing an example of calibration processing.

FIG. 9 is an explanatory diagram for describing a first feedback example according to an embodiment of the present disclosure.

FIG. 10 is an explanatory diagram for describing a second feedback example according to an embodiment of the present disclosure.

FIG. 11 is an explanatory diagram for describing a third feedback example according to an embodiment of the present disclosure.

FIG. 12 is a flowchart illustrating a whole operation of an information processing apparatus 10 according to an embodiment of the present disclosure.

FIG. 13 is a flowchart illustrating similarity calculation processing of the information processing apparatus 10 according to an embodiment of the present disclosure.

FIG. 14 is a block diagram illustrating a hardware configuration example of an information processing apparatus 90 according to an embodiment of the present disclosure.

### DESCRIPTION OF EMBODIMENTS

An embodiment of the present disclosure is hereinafter described in detail with reference to the accompanying drawings. Note that, in this specification and the drawings, the components having substantially the same functional configuration are assigned with the same reference sign and the description thereof is not repeated.

Furthermore, the “mode for carrying out the technology” is described according to the order of items described below.
1. Outline of information processing system
2. Functional configuration example of information processing apparatus 10
3. Details
3.1. General overview
3.2. Calculation of moment feature amount
3.3. Calculation of pose similarity
3.4. Feedback example
4. Motion processing example
5. Example of action and effect
6. Hardware configuration example
7. Supplement

### «1. Outline of Information Processing System»

As posture information regarding the user, skeleton data expressed by a skeleton structure indicating a structure of a body is used, for example, in order to visualize information regarding motions of a moving body such as a human and an animal. The skeleton data includes information regarding portions. Note that a portion in the skeleton structure corresponds to, for example, an end portion, a joint portion, or the like of a body. Furthermore, the skeleton data may include bones that are line segments connecting portions. Bones in the skeleton structure can correspond to, for example, human bones, but positions and the number of bones do not necessarily match the actual human skeleton.

A position and posture of each portion in the skeleton data can be acquired by a sensor that detects the motion of the user. For example, there are a technique of detecting a position and posture of each portion of the body on the basis of time-series data of image data acquired by an imaging sensor, and a technique of attaching a motion sensor to a portion of the body and acquiring the position and posture of each portion (position information from the motion sensor) on the basis of time-series data acquired by the motion sensor.

Furthermore, the skeleton data has various uses. For example, the time-series data of the skeleton data is used for form improvement in sports, or used for an application, for example, virtual reality (VR), augmented reality (AR), or the like. Furthermore, an avatar video imitating the motion of the user is generated using the time-series data of the skeleton data, and the avatar video is distributed.

According to an embodiment of the present disclosure, the skeleton data is used in processing of calculating a degree of similarity of poses of a plurality of users. Specifically, the information processing system according to an aspect of the present disclosure uses the information regarding the lengths of the bones constituting the skeleton data in the processing of calculating the degree of similarity of poses of the plurality of users. With this arrangement, it is possible to further reduce the arithmetic load relating to similarity determination.

As an embodiment of the present disclosure, first, a configuration example of an information processing system is described. The information processing system estimates skeleton data including position information regarding each portion of a user; and calculates a moment feature amount having at least scale invariance or translation invariance on the basis of lengths of two or more bones included in the skeleton data. Note that, although a human will be mainly described below as an example of a moving body, an embodiment of the present disclosure is similarly applicable to other moving bodies such as an animal and a robot.

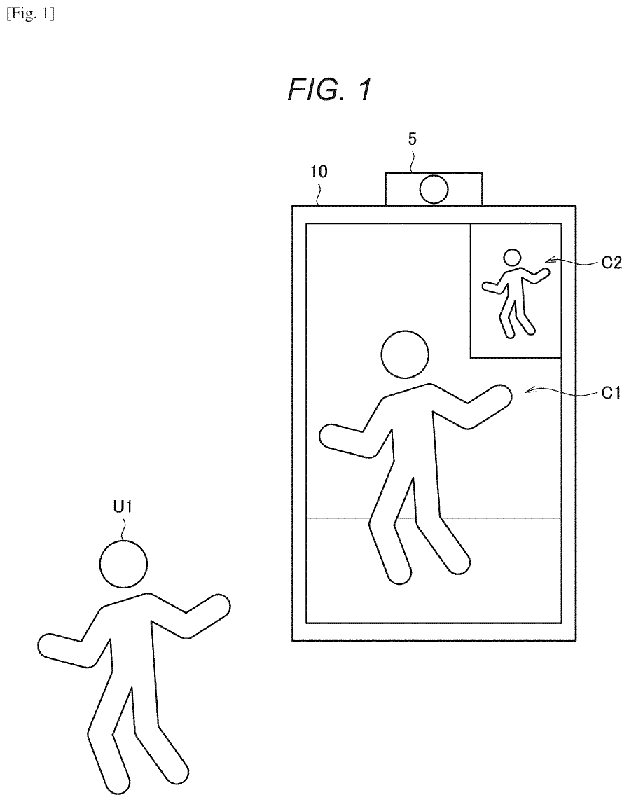

FIG. 1 is an explanatory diagram illustrating an information processing system according to an embodiment of the present disclosure. As illustrated in FIG. 1, the information processing system according to an embodiment of the present disclosure includes a camera 5 and an information processing apparatus 10.

### (Camera 5)

The camera 5 according to an aspect of the present disclosure acquires image data by imaging a user U1. Furthermore, the camera 5 outputs the image data obtained by imaging to the information processing apparatus 10. Here, the image data is assumed to be data of a motion video image mainly including a plurality of frames, but may be data of a still image including one frame.

### (Information Processing Apparatus 10)

The information processing apparatus 10 according to an aspect of the present disclosure estimates skeleton data including position information regarding each portion of the user U1. Furthermore, the information processing apparatus 10 calculates a moment feature amount having at least scale invariance and translation invariance on the basis of the lengths of two or more bones included in the estimated skeleton data. Details about estimation of the skeleton data and calculation of the moment feature amount will be described later.

Furthermore, the information processing apparatus 10 calculates a degree of similarity of poses between the user U1 and the other user, and generates feedback information according to the calculation result.

Furthermore, as illustrated in FIG. 1, the information processing apparatus 10 displays a video C1 including the user U1. Furthermore, as illustrated in FIG. 1, the information processing apparatus 10 displays a video C2 including the other user. Moreover, the information processing apparatus 10 may output the feedback information as video or audio.

The user U1 performs a wide variety of motions while confirming his/her own video C1 displayed by the information processing apparatus 10 and the video C2 of the other user (for example, a model user). For example, in a case where a certain user U1 performs dance practice, the user U1 can practice the dance while confirming the video C2 including a dance instructor as an example of another user and the video C1 of the user U1. In this manner, the user practicing motions while reproducing the motion of the dance instructor can increase the improvement speed of the dance of the user.

Note that, in FIG. 1, an installation type apparatus is illustrated as the information processing apparatus 10, but the information processing apparatus 10 according to an aspect of the present disclosure is not limited to such an example. The information processing apparatus 10 may be another apparatus such as a personal computer (PC), a smartphone, a tablet terminal, and a server, for example.

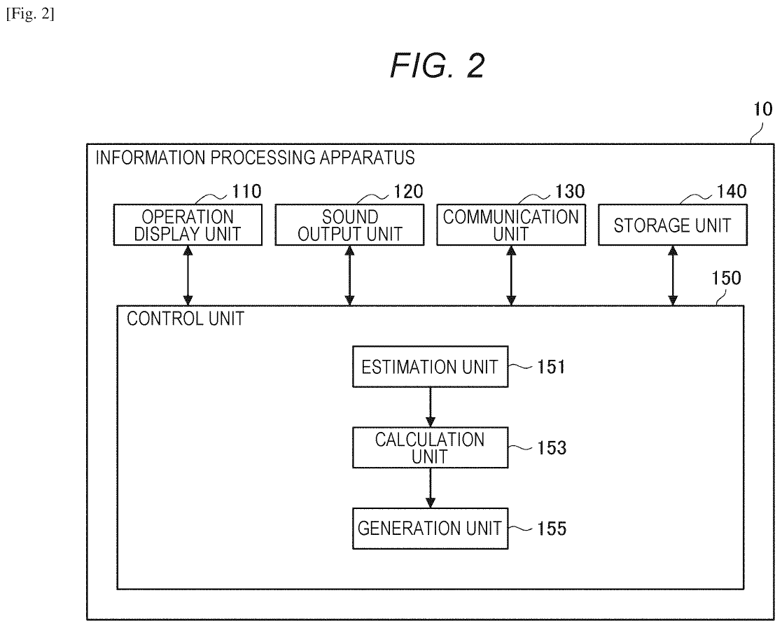

The overview of the information processing system according to an aspect of the present disclosure has been described above. Next, with reference to FIG. 2, a specific example of the functional configuration of the information processing apparatus 10 will be sequentially described.

### «2. Functional Configuration Example of Information Processing Apparatus 10»

FIG. 2 is an explanatory diagram illustrating an example of a functional configuration of the information processing apparatus 10 according to an aspect of the present disclosure. As illustrated in FIG. 2, the information processing apparatus 10 according to an aspect of the present disclosure includes an operation display unit 110, a sound output unit 120, a communication unit 130, a storage unit 140, and a control unit 150.

### <Operation Display Unit 110>

The operation display unit 110 according to an aspect of the present disclosure includes a function as an operation unit that receives a user's operation and a function as a display unit that displays feedback information and a superimposed screen generated by a generation unit 155 described later. Specific examples of the feedback information and the superimposed screen will be described later. Furthermore, the operation display unit 110 may display the video C1 of the user illustrated in FIG. 1 included in the image data obtained by imaging by the camera 5 and the video C2 of the other user included in the image data obtained by the communication unit 130 described later. Note that the operation display unit 110 is an example of an output unit.

The function as the operation unit can be implemented by, for example, a touch panel, a keyboard, or a mouse.

Furthermore, the function as the display unit can be implemented by, for example, a touch panel, a cathode ray tube (CRT) display apparatus, a liquid crystal display (LCD) apparatus, and an organic light-emitting diode (OLED) apparatus.

Note that the information processing apparatus 10 has a configuration in which the functions of the operation unit and the display unit are integrated, but may have a configuration in which the functions of the operation unit and the display unit are separated. Furthermore, the information processing apparatus 10 does not necessarily have a configuration including the function of the operation unit.

### <Sound Output Unit 120>

The sound output unit 120 according to an embodiment of the present disclosure includes a voice output function that outputs feedback information generated by the generation unit 155 described later. Furthermore, the sound output unit 120 may output audio data received by the communication unit 130 described later from another apparatus. Note that the sound output unit 120 is an example of the output unit.

The function as the sound output unit 120 can be implemented by various apparatuses such as a speaker, a headphone, and an earphone, for example.

Note that, in the present specification, an example in which the operation display unit 110 and the sound output unit 120 are output units will be mainly described, but the information processing apparatus 10 may include only one of the operation display unit 110 or the sound output unit 120 as an output unit.

### <Communication Unit 130>

The communication unit 130 according to an aspect of the present disclosure transmits or receives a signal including various types of information to or from the other apparatus via a network. For example, the communication unit 130 may transmit image data acquired by imaging the user U1 by the camera 5 to the other apparatus. Furthermore, the communication unit 130 may receive image data, having been acquired by imaging the other user by a camera included in the other apparatus, from that apparatus. Here, the other apparatus may be, for example, an apparatus having the same functional configuration as the information processing apparatus 10.

Furthermore, the communication unit 130 may transmit audio data obtained by a microphone included in the information processing apparatus 10, but not illustrated, to the other apparatus. Furthermore, the communication unit 130 may receive voice data obtained by a microphone included in the other apparatus.

Furthermore, the communication unit 130 may transmit information regarding various types of pose similarity, for example, a degree of similarity, a similarity score, or a combined similarity score described later to the other apparatus used by the other user. In a case where the other user is a dance instructor and the user is a student, the operation display unit of the other apparatus feeds back the information regarding the pose similarity to the dance instructor, so that the dance instructor can proceed with the dance class while confirming the degree of performance of the dance of the student.

### <Storage Unit 140>

The storage unit 140 according to an aspect of the present disclosure holds software and various data. For example, the storage unit 140 holds similarity scores obtained from each of a plurality of frames included in image data.

### <Control Unit 150>

The control unit 150 according to an aspect of the present disclosure controls the overall operation of the information processing apparatus 10. As illustrated in FIG. 2, the control unit 150 according to an aspect of the present disclosure includes an estimation unit 151, a calculation unit 153, and a generation unit 155.

### (Estimation Unit 151)

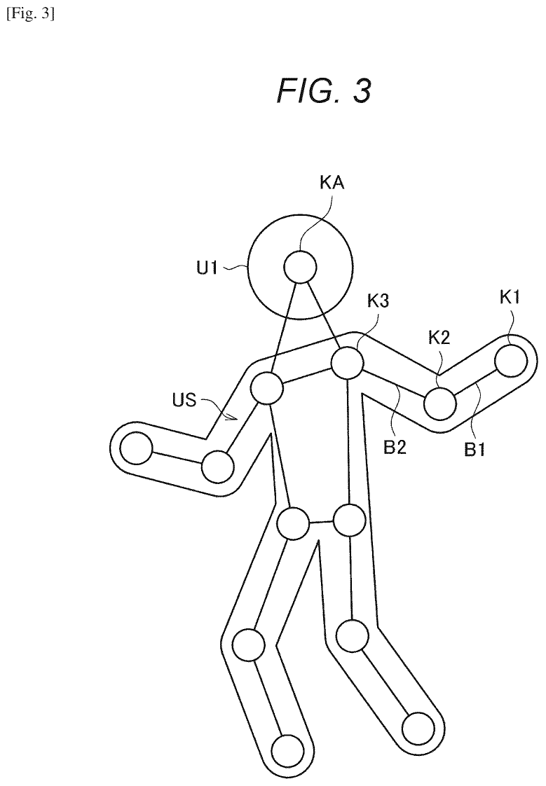

The estimation unit 151 according to an aspect of the present disclosure estimates skeleton data including position information regarding each portion of the user. The skeleton data may further include posture information regarding each portion of the user. Here, with reference to FIG. 3, a specific example related to estimation of skeleton data is described.

FIG. 3 is an explanatory diagram for describing a specific example related to estimation of skeleton data. For example, the estimation unit 151 acquires the skeleton data US including the position information and the posture information regarding each portion in the skeleton structure on the basis of the image data acquired by the camera 5.

For example, the estimation unit 151 may generate the skeleton data US of the user U1 using machine learning such as deep neural network (DNN). More specifically, for example, the estimation unit 151 may generate the skeleton data US of the user U1 using an estimator obtained by machine learning using a set of image data acquired by imaging a person and skeleton data as teacher data. However, the method of estimating the skeleton data US by the estimation unit 151 is not limited to such an example.

Note that the skeleton data US includes bone information (position information, posture information, skeleton feature information, and the like) in addition to information regarding each portion. For example, the skeleton data US can include a bone B1 connecting a left hand K1 and a left elbow K2 and a bone B2 connecting the left elbow K2 and a left shoulder K3. As described above, the skeleton data US includes a plurality of portions K and a plurality of bones B connecting the plurality of portions K.

Note that, in the following description, there is a case where a portion is referred to as joint point, but the joint point herein does not necessarily correspond to an actual joint of a human. For example, the joint point may include a head KA that is different from an actual joint. Furthermore, the joint points may be provided at positions of eyes included in the head KA, or a plurality of the joint points may be further provided between the left hand K1 and the left elbow K2. As described above, the joint point and the bone may be provided at any desired positions as long as the skeleton data US can hold a shape of the user U1.

Note that, although FIG. 3 illustrates the skeleton data US of the entire body of the user U1, the estimation unit 151 does not necessarily estimate the skeleton data US of the entire body, and may estimate the skeleton data US of only a portion (for example, only an upper body or a hand, or the like) according to a use case.

### (Calculation Unit 153)

The calculation unit 153 according to an aspect of the present disclosure calculates a moment feature amount having at least scale invariance and translation invariance on the basis of the lengths of two or more bones included in the estimated skeleton data estimated by the estimation unit 151.

Furthermore, the calculation unit 153 may calculate a moment feature amount having rotation invariance in addition to scale invariance and translation invariance. Details of each moment feature amount will be described later.

Furthermore, the calculation unit 153 may calculate a degree of similarity of poses on the basis of a plurality of moment feature amounts calculated from the respective pieces of skeleton data of a plurality of users. For example, the calculation unit 153 calculates the degree of similarity of poses performed by the user and the other user on the basis of a moment feature amount calculated from skeleton data of the user who performs a certain pose and a moment feature amount calculated from skeleton data of the other user who performs the same pose as the user.

### (Generation Unit 155)

The generation unit 155 according to an aspect of the present disclosure generates feedback information based on a degree of similarity of poses of a plurality of users. As detailed later, the feedback information includes, for example, color information, character information, or sound information.

Furthermore, the generation unit 155 may generate a superimposed screen in which reference skeleton data of the other user including reference bone converted according to the length of each portion of the user is superimposed on each portion of the user included in the motion video.

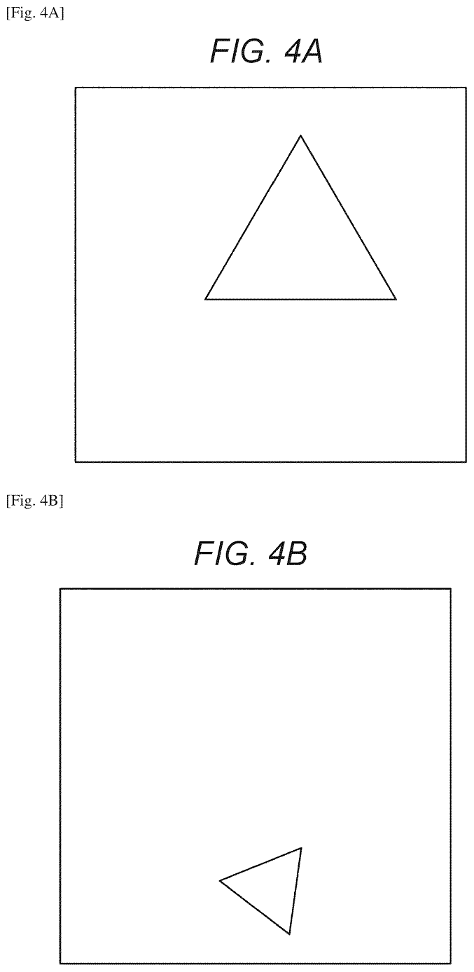

In the foregoing, an example of the functional configuration of the information processing apparatus 10 according to an aspect of the present disclosure has been described. Next, with reference to FIGS. 4 to 10, details of the information processing system according to an aspect of the present disclosure will be described.

### «3. Details»

### <3.1. General Overview>

There is a case where a certain user, in practicing motions of dance, yoga, fitness, sports, rehabilitation, and the like, may improve his/her performance by referring to a pose (for example, movement and positioning) of the other user as a model and performing practice so that the user's own pose approaches the pose of the other user.

In such a case, by feeding back the degree of similarity of pose (hereinafter sometimes expressed as pose similarity) of the user with respect to the pose of the other user as a model to the user, the user can quantitatively grasp how close to the target pose (that is, a pose of the other user), and the improvement speed related to the acquisition of the motions can be accelerated.

Here, depending on users, motions to practice and learn can be different. Therefore, a method of calculating the pose similarity corresponding to (a motion video including) an arbitrary motion is desirable.

Furthermore, it can be difficult to completely match the position and posture of the camera that images the user with the position and posture of the camera that images the other user as a model. Therefore, a method of calculating the pose similarity that is not affected by the deviation of a position and posture of the camera is desirable.

Furthermore, if it is possible to feedback the pose similarity to the user in real time, the improvement speed related to learning motions of the user can be accelerated.

Therefore, the similarity calculation processing by the information processing apparatus 10 according to an aspect of the present disclosure corresponds to (a motion video including) an arbitrary motion, but does not depend on the position and posture of the camera, and further enables feedback of the pose similarity in real time. Hereinafter, details of processing that enables each requirement to be satisfied will be sequentially described.

### <3.2. Calculation of Moment Feature Amount>

The information processing apparatus 10 according to an aspect of the present disclosure uses a moment feature amount having at least scale invariance and translation invariance in calculation of pose similarity. The moment feature amount according to an aspect of the present disclosure may further have rotation invariance.

FIGS. 4A and 4B are explanatory diagrams for describing a specific example of the moment feature amount according to an aspect of the present disclosure. Hu moment exists as an example of a moment feature amount having scale invariance, translation invariance, and rotation invariance.

The Hu moment is a feature amount that can be used for similarity determination of shapes included in an image. For example, it is possible to extract an amount invariable with respect to translation, scale, and rotation of a certain shape as Hu moment.

For example, the image illustrated in FIG. 4A and the image illustrated in FIG. 4B have the same triangular shape. Here, the triangle illustrated in FIG. 4A and the triangle illustrated in FIG. 4B are different from each other in the position, the scale, and the rotation direction in the image, but the Hu moment calculated from the image has the same amount because the shapes of the triangles are the same.

Therefore, the information processing apparatus 10 according to an aspect of the present disclosure applies the Hu moment to pose information to calculate a feature amount of a pose that is invariable with respect to translation, scale, and rotation. With this arrangement, it is possible to calculate the pose similarity without being affected by the position and posture of the camera that images the user.

Furthermore, since calculation load is reduced compared with machine learning or the like, it is possible to reduce restrictions on the device, and moreover, the pose similarity can be calculated in real time because of the reduction of the calculation load. Hereinafter, specific methods relating to the calculation of the Hu moment will be sequentially described. First, prior to description of a method of calculating a moment feature amount applied to the pose information, details related to calculation of a general moment feature amount will be described.

### —General Moment Feature Amount

### (Raw Moment)

First, a raw moment Ma is calculated by the following mathematical expression (1). Here, x is an x coordinate in a two-dimensional image, and y is a y coordinate in the two-dimensional image. All the pixels of the two-dimensional image are sequentially substituted into Σ. Furthermore, 1 is a normal value (1 or 0) of the binary image, and a pixel having a shape is 1 and a pixel having no shape is 0. For example, a pixel having a shape and a pixel having no shape can be discriminated by extracting a feature point from an image and performing binary image conversion on the extracted feature point.

$$[ Math . 1 ]$$

$${M}_{ij} = {\sum }_{x} {\sum }_{y} {x}^{i} {y}^{j} I ( x , y ) \qquad ( 1 )$$

Here, the centroid x_{c} of the x-axis and the centroid y_{c} of the y-axis of a pixel having a shape are calculated by the following mathematical expression (2).

$$[ Math . 2 ]$$

$${x}_{c} = \frac{{M}_{10}}{{M}_{00}} , {y}_{c} = \frac{{M}_{01}}{{M}_{00}} \qquad ( 2 )$$

### (Central Moment)

A central moment Cᵢⱼ is a moment feature amount having translation invariance. The central moment Cᵢⱼ is calculated by the following mathematical expression (3). Here, C₀₀ is a total value of pixels having a shape, in other words, corresponds to an area of pixels having a shape.

$$[ Math . 3 ]$$

$${C}_{ij} = {\sum }_{x} {\sum }_{y} {( x - {x}_{c} )}^{i} {( y - {y}_{c} )}^{j} I ( x , y ) \qquad ( 3 )$$

### (Normal Central Moment)

A normal central moment Rᵢⱼ is a moment feature amount having scale invariance and translation invariance. The normal central moment Ry is calculated by the following mathematical expression (4).

$$[ Math . 4 ]$$

$$\begin{matrix}{R}_{ij} = {\sum }_{x} {\sum }_{y} {( \frac{x - {x}_{c}}{{C}_{00}^{\frac{1}{2}}} )}^{i} {( \frac{y - {y}_{c}}{{C}_{00}^{\frac{1}{2}}} )}^{j} I ( x , y ) \\ = \frac{{C}_{ij}}{{C}_{00}^{( 1 + \frac{i + j}{2} )}}\end{matrix} \qquad ( 4 )$$

### (Hu Moment)

Hu moments I₁ to I₇ each are a moment feature amount having rotation invariance, scale invariance, and translation invariance. The Hu moments I₁ to I₇ each are calculated by the following mathematical expressions (5) to (11). Furthermore, a supplementary expression I₈ for supplementing the Hu moments I₁ to I₇ is calculated by the following mathematical expression (12).

$$[ Math . 5 ]$$

$${I}_{1} = {R}_{20} + {R}_{02} \qquad ( 5 )$$

$$[ Math . 6 ]$$

$${I}_{2} = {( {R}_{20} + {R}_{02} )}^{2} + 4 {R}_{11}^{2} \qquad ( 6 )$$

$$[ Math . 7 ]$$

$${I}_{3} = {( {R}_{30} - 3 {R}_{12} )}^{2} + {( 3 {R}_{21} - {R}_{03} )}^{2} \qquad ( 7 )$$

$$[ Math . 8 ]$$

$${I}_{4} = {( {R}_{30} + {R}_{12} )}^{2} + {( {R}_{21} + {R}_{03} )}^{2} \qquad ( 8 )$$

$$[ Math . 9 ]$$

$${I}_{5} = ( {R}_{30} - 3 {R}_{12} ) ( {R}_{30} + {R}_{12} ) [ {( {R}_{30} + {R}_{12} )}^{2} - 3 {( {R}_{21} - {R}_{03} )}^{2} ] + ( 3 {R}_{21} - {R}_{03} ) ( {R}_{21} + {R}_{03} ) [ 3 {( {R}_{30} + {R}_{12} )}^{2} - {( {R}_{21} + {R}_{03} )}^{2} ] \qquad ( 9 )$$

$$[ Math . 10 ]$$

$${I}_{6} = ( {R}_{20} − {R}_{02} ) [ {( {R}_{30} + {R}_{12} )}^{2} − {( {R}_{21} + {R}_{03} )}^{2} ] + 4 {R}_{13} ( {R}_{30} + {R}_{12} ) ( {R}_{21} + {R}_{03} ) \qquad ( 10 )$$

$$[ Math . 11 ]$$

$${I}_{7} = ( 3 {R}_{21} − {R}_{03} ) ( {R}_{30} + {R}_{12} ) [ {( {R}_{30} + {R}_{12} )}^{2} − 3 {( {R}_{21} + {R}_{03} )}^{2} ] − ( {R}_{30} − 3 {R}_{12} ) ( {R}_{21} + {R}_{03} ) [ 3 {( {R}_{30} + {R}_{12} )}^{2} − {( {R}_{21} + {R}_{03} )}^{2} ] \qquad ( 11 )$$

$$[ Math . 12 ]$$

$${I}_{8} = {R}_{11} [ {( {R}_{30} + {R}_{12} )}^{2} − {( {R}_{03} + {R}_{21} )}^{2} ] − ( {R}_{20} − {R}_{02} ) ( {R}_{30} + {R}_{12} ) ( {R}_{03} + {R}_{21} ) \qquad ( 12 )$$

The general method of calculating the moment feature amount has been described above. In the general method of calculating the moment feature amount, various moment feature amounts such as a raw moment, a central moment, a normal central moment, Hu moment, and the like are calculated using numerical values of all pixels in the two-dimensional image.

When such a general moment feature amount is applied to the pose information, for example, in a case where shapes (for example, physique) of the respective users are different from each other, Hu moments that are not the same amount can be calculated even if both users are in the same pose. Therefore, due to such a difference in shape between the users, the pose similarity can also be calculated to be low. Furthermore, in the above-described example, since the moment feature amount is calculated using the numerical values of all the pixels, the calculation load of the information processing apparatus 10 can be increased.

Therefore, the moment feature amount according to an aspect of the present disclosure reduces the physique dependency of the user related to the calculation of the pose similarity, and moreover, reduces the calculation load. More specifically, when calculating the moment feature amount, the information processing apparatus 10 according to an aspect of the present disclosure uses not all the pixels but only numerical values of pixels in which respective bones (respective joint points) constituting the skeleton data of the user are located.

### —Moment Feature Amount Applied to Pose Information

The mathematical expressions for calculating the moment feature amounts applied to the pose information are the same as the mathematical expressions (1) to (12) described above except for the mathematical expression (4) for calculating the normal central moment, and thus overlapping detailed descriptions are omitted. However, in the mathematical expressions (1) to (3), x is changed to the x coordinate of each joint point of the bone included in the two-dimensional image, and y is changed to the y coordinate of each joint point of the bone included in the two-dimensional image. Furthermore, all the joint points of the bone included in the two-dimensional image are sequentially substituted into Σ.

The mathematical expression (4) calculating the normal central moment is replaced by the following mathematical expression (13). A mathematical expression (13) is a mathematical expression in which a length component of an area of a pixel having a shape of the mathematical expression (4) (that is, a square root of the area C₀₀) is replaced by the length L of the bone. Furthermore, similarly to the mathematical expressions (1) to (3), in the mathematical expression (13), x is the x coordinate of each joint point of the bone included in the two-dimensional image, and y is the y coordinate of each joint point of the bone included in the two-dimensional image. Furthermore, all the joint points of the bone included in the two-dimensional image are sequentially substituted into Σ.

$$[ Math . 13 ]$$

$$\begin{matrix}{R}_{ij} = {\sum }_{x} {\sum }_{y} {( \frac{x - {x}_{c}}{L} )}^{i} {( \frac{y - {y}_{c}}{L} )}^{j} \\ = \frac{{C}_{ij}}{{C}_{00} {L}^{i + j}}\end{matrix} \qquad ( 13 )$$

Here, the length L of the bone is calculated by the following mathematical expression (14). In the mathematical expression (14), p and q are a combination connecting joint points of bones, and a necessary joint point may be arbitrarily selected. Note that, in the example of the skeleton data US illustrated in FIG. 3, the combination of connecting the joint points of the bones includes 14 pieces constituting a human shape.

$$[ Math . 14 ]$$

$$L = {\sum }_{p , q} {( {( {x}_{p} - {x}_{q} )}^{2} + {( {y}_{p} - {y}_{q} )}^{2} )}^{\frac{1}{2}} \qquad ( 14 )$$

According to the moment feature amount applied to the pose information according to an aspect of the present disclosure described above, since the skeleton information is used, the influence of the difference in shape (physique) between the users can be suppressed, and moreover, the calculation load of the information processing apparatus 10 can be reduced by reducing the number of pixels used to calculate the moment feature amount.

The details related to the calculation of the moment feature amount of the calculation unit 153 according to an aspect of the present disclosure have been described above. Next, details related to similarity calculation using the above-described moment feature amount will be described.

### <3.3. Calculation of Pose Similarity>

The calculation unit 153 calculates, on the basis of skeleton data of the user who performs a certain pose and a moment feature amount calculated from skeleton data of the other user who performs the same pose as the user, respective moment feature amounts, and calculates pose similarity from the calculated respective feature amount. In the following description, there is a case where a moment feature amount calculated from skeleton data of a user is expressed as a user feature amount, and a moment feature amount calculated from skeleton data of the other user is expressed as a model feature amount.

For example, the calculation unit 153 calculates a degree of similarity of poses of a plurality of users for each corresponding frame on the basis of a plurality of moment feature amounts calculated for each corresponding frame in a plurality of motion videos. The corresponding frames here are frames in which a certain same motion is performed, and indicate, for example, a pair of frames whose times correspond to each other after the image data of a user and the image data of the other user are time-synchronized.

In a case where the moment feature amount is Hu moment I (including supplementary expression), the user feature amount I^{a} includes I₁^{a} to I₈^{a}, and the model feature amount I_{b} includes I₁^{b} to I₈^{b}.

The calculation unit 153 may calculate a degree of similarity D by any of the following mathematical expressions (15) to (17).

$$[ Math . 15 ]$$

$$D = {{\sum }_{n = 1}}^{8} \vert \frac{1}{{H}_{n}^{b}} - \frac{1}{{H}_{n}^{a}} \vert \qquad ( 15 )$$

$$[ Math . 16 ]$$

$$D = {{\sum }_{n = 1}}^{8} \vert {H}_{n}^{b} - {H}_{n}^{a} \vert \qquad ( 16 )$$

$$[ Math . 17 ]$$

$$D = {{\sum }_{n = 1}}^{8} \vert \frac{{H}_{n}^{b} - {H}_{n}^{a}}{{H}_{n}^{a}} \vert \qquad ( 17 )$$

Here, Hn is a logarithmic scale value and is calculated by the following mathematical expression (18).

$$[ Math . 18 ]$$

$${H}_{n} = - sign ( {I}_{n} ) log \vert {I}_{n} \vert \qquad ( 18 )$$

However, the degree of similarity D is not limited to the above-described example, and may be changed according to the application such as cosine similarity. Furthermore, in a case where it is desired to eliminate invariance with respect to rotation, or the like, the normal central moment R may be substituted instead of the Hu moment I in the mathematical expression (18).

Furthermore, in the mathematical expressions (15) to (17) described above, the supplementary expression Is of the Hu moment shown in the mathematical expression (12) is not necessarily be used. In the above case, the mathematical expressions (15) to (17) can be expressed by a sequence expression of n=1 to 7.

Furthermore, the calculation unit 153 may convert the calculated degree of similarity D into a similarity score s converted into a range from 0 to 1. Here, the similarity score s is calculated by the following mathematical expressions (19) and (20) where the similarity score is 1 if the similarity is highest.

$$[ Math . 19 ]$$

$$s = exp ( - kD ) \qquad ( 19 )$$

$$[ Math . 20 ]$$

$$s = exp ( - {( \frac{D}{{w}_{1}} )}^{{w}_{2}} ) ) \qquad ( 20 )$$

Here, k in the mathematical expression (19) and w₁ and w₂ in the mathematical expression (20) are arbitrary setting parameters, and may be set as appropriate. Furthermore, the mathematical expression for calculating the similarity score s is not limited to the mathematical expression (19) or (20).

The calculation unit 153 may perform each process related to the calculation of the similarity score s from the estimation of the skeleton data as described above in each frame of the image data, and store the similarity score s of each frame in the storage unit 140. Then, the calculation unit 153 may calculate the combined similarity score based on the similarity score s calculated for all the frames (or a plurality of frames to be subjected to similarity evaluation) of the image data.

For example, the calculation unit 153 may calculate an average value of the similarity scores s calculated in the plurality of frames as the combined similarity score. With this arrangement, it is possible to feedback comprehensive evaluation of a series of motions included in the motion video to the user as the combined similarity score.

The various processes of the calculation of the moment feature amount, the calculation of the pose similarity, and the like have been described above. However, the method of calculating the moment feature amount and the method of calculating the pose similarity are not limited to the above-described examples. The contents of the various types of calculation processing may be modified according to the use case as appropriate.

For example, not all the bones are necessarily used for the calculation of the moment feature amount, and at least two or more bones may be used. For example, in a case where the pose similarity of the upper body is calculated, the moment feature amount may be calculated using information regarding the bone of only the upper body and the joint points constituting the bone of the upper body.

Furthermore, instead of calculating the pose similarity of the entire body of the user, the calculation unit 153 may calculate the moment feature amount from the length of a specific bone (for example, a bone including actual finger joints) of a portion such as a finger and calculate the pose similarity of the portion.

Furthermore, the calculation unit 153 may calculate a degree of similarity of three-dimensional poses by extending the moment feature amount such as the Hu moment to three dimensions.

Furthermore, the calculation unit 153 may calculate the pose similarity of three or more users instead of the pose similarity of two users, that is, the user and the other user. In the above case, the calculation unit 153 may calculate a degree of similarity of respective poses of a plurality of other users with respect to a certain reference user as the pose similarity, or may calculate an average value of similarity of poses of the respective users as the pose similarity.

Furthermore, a plurality of users may be imaged by different cameras 5, or may be imaged by the same camera 5. In a case where a plurality of users is imaged by the same camera 5, the estimation unit 151 may estimate the respective pieces of the skeleton data of the plurality of users from the same image data. Then, the calculation unit 153 may calculate a link state of poses of the plurality of users as the pose similarity on the basis of the skeleton data of the plurality of users.

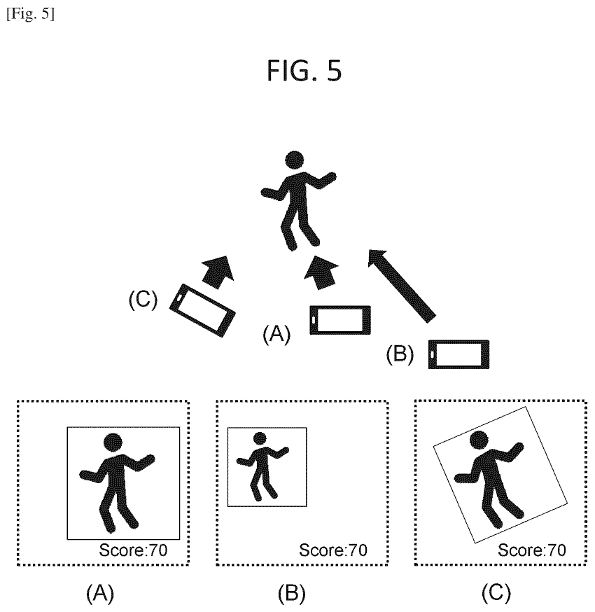

FIG. 5 is an explanatory diagram for describing an example of similarity scores when the position or posture of the same camera 5 is different. In FIG. 5, the similarity score is 70 when the camera 5 is located at different positions or postures. For example, in a case where a user is imaged by the camera 5 at a first position and a first posture, the similarity score is 70, in a case where the user is imaged by the camera 5 at a second position and a second posture, the similarity score is 70, and in a case where the user is imaged by the camera 5 at a third position and a third posture, the similarity score is 70. Accordingly, as shown in FIG. 5, the pose similarity at each of the first, second, and third positions and postures are the same. Therefore, a method of calculating the pose similarity that is not affected by the deviation of a position and posture of the camera is possible. Furthermore, in FIG. 5, at least one of the first position is different than the second position or the first posture is different than the second posture. Thus, either the first position is different than the second position and the first posture is same as the second posture, the first position is same as the second position and the first posture is different than the second posture, or the first position is different than the second position and the first posture is different than the second posture.

Furthermore, depending on the use environment on the user, a case may be assumed where the estimation accuracy of the skeleton data of the user estimated from the image data obtained by imaging by the camera 5 decreases, or other cases.

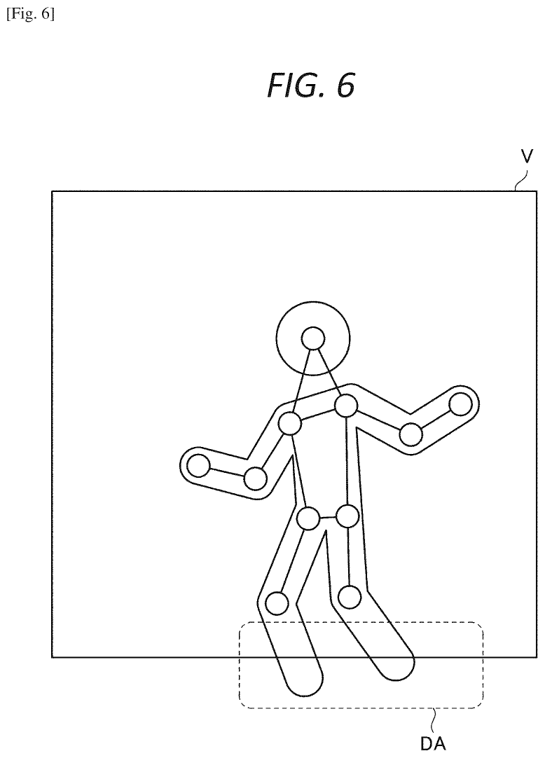

FIG. 6 is an explanatory diagram for describing an example of a factor that can reduce estimation accuracy of skeleton data. For example, as illustrated in FIG. 6, if the leg portion DA of the user does not fall within the view angle V of the camera 5, the estimation accuracy of the bone and the joint points of the leg portion DA of the user can be reduced. Furthermore, if the user blends in with a background, the estimation accuracy of the bones and joint points of the user can be reduced.

Therefore, the estimation unit 151 may further estimate the reliability score of the joint points on the basis of the image data acquired by the camera 5. The reliability score here is an index indicating the reliability of the estimated value of the joint point, and the higher the reliability of the estimated value, the higher the reliability score is estimated. For example, as illustrated in FIG. 6, in a case where the leg portion DA of the user does not fall within the view angle V of the camera 5, the estimation unit 151 estimates that the reliability score of the joint point of the leg portion DA is lowered compared with other joint portions.

Then, the calculation unit 153 may calculate the moment feature amount on the basis of the reliability score estimated for each joint point at both ends of the bone.

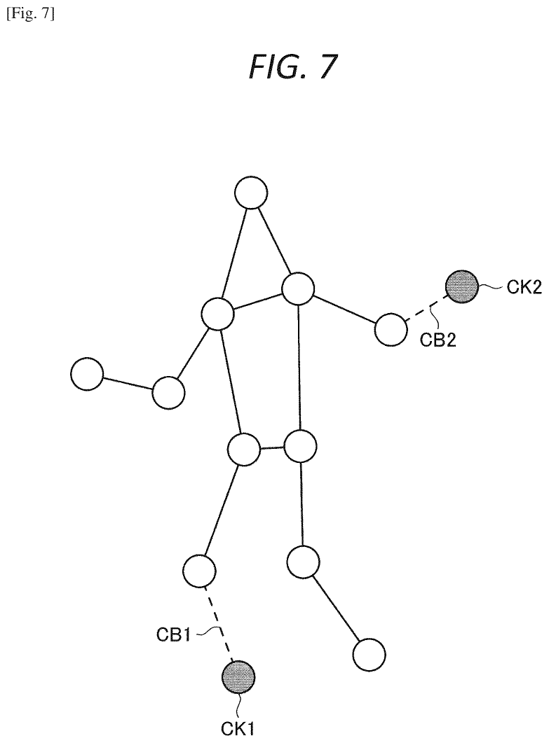

FIG. 7 is an explanatory diagram for describing a specific example related to calculation of a moment feature amount based on reliability score. Then, the calculation unit 153 may calculate the moment feature amount on the basis of the length of the bone including the joint points estimated that the reliability score is equal to or greater than a predetermined value, for example.

For example, in the skeleton data of the user illustrated in FIG. 7, in a case where the reliability score of a joint point CK1 of the right foot is estimated to be less than the predetermined value, the calculation unit 153 may calculate the moment feature amount on the basis of the length of each bone excluding a bone CB1 including the joint point CK1 of the right foot.

Moreover, in a case where the reliability score of a joint point CK2 of the left hand is estimated to be less than the predetermined value in the skeleton data of the other user to be subjected to calculating the pose similarity, the calculation unit 153 may calculate the moment feature amount on the basis of the length of each bone excluding the bone CB1 including the joint point CK1 of the right foot and the bone CB2 including the joint point CK2 of the left hand.

Furthermore, the calculation unit 153 may adopt a smaller reliability score between each joint point of the skeleton data of the user and each joint point of the skeleton data of the other user, and execute weighting processing based on the adopted reliability score. Then, the calculation unit 153 may calculate the pose similarity of the user and the other user on the basis of a plurality of moment feature amounts for which the weighting processing has been executed.

More specifically, the calculation unit 153 may execute the weighting processing by the following mathematical expression (21) or (22). Here, c is a reliability score, cₐ indicates a reliability score of the user side, and c_{b} indicates a reliability score of the other user side. In the calculation example represented in the mathematical expressions (21) and (22), weighting is performed by adopting a smaller reliability score from the reliability score cₐ on the user side and the reliability score c_{b} on the other user side.

$$[ Math . 21 ]$$

$${M}_{ij} = {\sum }_{x} {\sum }_{y} {x}^{i} {y}^{j} \cdot min ( {c}^{a} , {c}^{b} ) \qquad ( 21 )$$

$$[ Math . 22 ]$$

$${C}_{ij} = {\sum }_{x} {\sum }_{y} {( x - {x}_{c} )}^{i} {( y - {y}_{c} )}^{i} \cdot min ( {c}^{a} , {c}^{b} ) \qquad ( 22 )$$

Furthermore, the Hu moment according to an aspect of the present disclosure has invariance with respect to translation, scale, and rotation, but is affected by a difference in skeleton between users. For example, the length of each bone can be different between the user and the other user due to a difference in skeleton. As described above, when the lengths of the bones are different between the users, the moment feature amounts do not necessarily have the same amount even in a case where both users are in the same pose.

Therefore, the calculation unit 153 according to an aspect of the present disclosure may calculate the moment feature amount on the basis of the lengths of the corrected bones obtained by the calibration processing of correcting the lengths of the bones of the plurality of users.

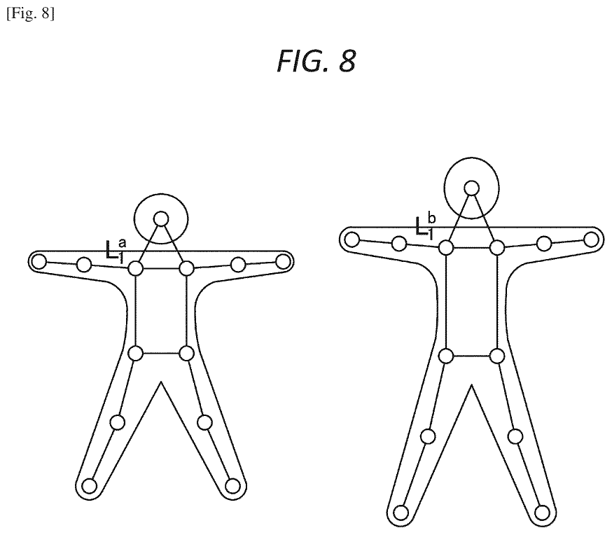

FIG. 8 is an explanatory diagram for describing an example of the calibration processing. For example, as a preparation for the calibration processing, a plurality of users stands with arms and legs outstretched as illustrated in FIG. 8. At this time, the estimation unit 151 estimates skeleton data including respective joint points of a plurality of users and a bone connecting the joint points. Note that, as long as accurate skeleton data of a plurality of users can be estimated, the plurality of users does not necessarily need to stand with arms and legs outstretched in the preparation. Furthermore, the plurality of users here includes a user on the left side and another user on the right side.

For example, the calculation unit 153 calculates the ratio of each bone to the length of all the bones in the skeleton data of the user. Moreover, the calculation unit 153 calculates the ratio of each bone to the length of all the bones in the skeleton data of the other user.

Then, the calculation unit 153 may adjust the length of the bone of the skeleton data of the user in accordance with the length of the bone of the skeleton data of the other user. Alternatively, the calculation unit 153 may adjust the length of the bone of the skeleton data of the other user in accordance with the length of the bone of the skeleton data of the user.

As a more specific example, in a case where the length L₁^{a} of the bone from the right shoulder to the right elbow of the skeleton data of the user illustrated in FIG. 8 is adjusted in accordance with the length L₁^{b} of the bone from the right shoulder to the right elbow of the skeleton data of the other user, the calculation unit 153 may adjust the length L₁^{a} of the bone by the following mathematical expression (23).

$$[ Math . 23 ]$$

$${L}_{1}^{a ′} = {L}_{1}^{a} \cdot ( \frac{{L}_{1}^{b}}{{L}^{b}} / \frac{{L}_{1}^{a}}{{L}^{a}} ) \qquad ( 23 )$$

Here, L₁^{a′} is the length of the bone from the right shoulder to the right elbow of the skeleton data of the user after the calibration processing is executed in accordance with the length of the bone of the other user, L^{a} is the length of all the bones of the skeleton data of the user, and L^{b} is the length of all the bones of the skeleton data of the other user.

By executing such calibration processing on each bone, the calculation unit 153 can calculate a moment feature amount that does not depend on a difference in skeleton between users.

Furthermore, there is a case where the estimation accuracy of the position of the bone estimated by the estimation unit 151 decreases, and in the above case, the position of the bone may vary between frames in a certain period. Therefore, the calculation unit 153 according to an aspect of the present disclosure may execute processing of averaging the positions of the joint points in the time direction.

For example, the calculation unit 153 may calculate the moment feature amount on the basis of the length of the bone including the joint points the positions of which are averaged in a plurality of frames included in a certain period. Specifically, the calculation unit 153 may calculate the moment feature amount of the target frame on the basis of each average value of lengths of two or more bones included in the skeleton data of each frame in a predetermined period from the target frame.

More specifically, in the mathematical expressions (1) to (3), (13), and (14) related to the calculation of the moment feature amount, the positions x and y of the joint points may be replaced with the average positions xₐᵥₑ and yₐᵥₑ of the joint points in the following expressions (24) and (25). Here, xₜ and yₜ are positions x and y of the joint points at time t. Furthermore, τ is the total number of frames in the period (period of time average), and an arbitrary value may be set.

$$[ Math . 24 ]$$

$${x}_{a ν e} = \frac{{x}_{t - r} + … + {x}_{t - 1} + {x}_{t}}{τ} \qquad ( 24 )$$

$$[ Math . 25 ]$$

$${y}_{a ν e} = \frac{{y}_{t - τ} + … + {y}_{t - 1} + {y}_{t}}{τ} \qquad ( 25 )$$

With this arrangement, even in a case where the position estimation accuracy of the bone decreases in a certain frame, decrease in the calculation accuracy of the pose similarity of the frame can be suppressed.

Furthermore, with respect to the moment feature amount of the skeleton data of the user in a certain target frame, the calculation unit 153 may temporarily calculate a degree of similarity of each moment feature amount of the skeleton data of the other user in a predetermined number of frames before and after the frame corresponding to the target frame.

Then, the calculation unit 153 may calculate the highest provisional value among the plurality of calculated provisional values of the degree of similarity as a confirmed value of the degree of similarity in the target frame. With this arrangement, the influence of the time deviation (synchronization deviation) between the image including the user and the image including the model (the other user) can be reduced.

Subsequently, a specific example of the feedback will be described with reference to FIGS. 8 to 10.

### <3.4. Feedback Example>

The information processing apparatus 10 according to an aspect of the present disclosure presents the feedback information based on the moment feature amount or the pose similarity (degree of similarity D, similarity score s or combined similarity score) described above to the user. Note that, in the following description, three types of examples will be described as the feedback screens FS1 to FS3, but the feedback screen according to an aspect of the present disclosure is not limited to such an example. Furthermore, the information processing apparatus 10 may present the feedback information to the user by combining various types of information included in the following feedback screens FS1 to FS3.

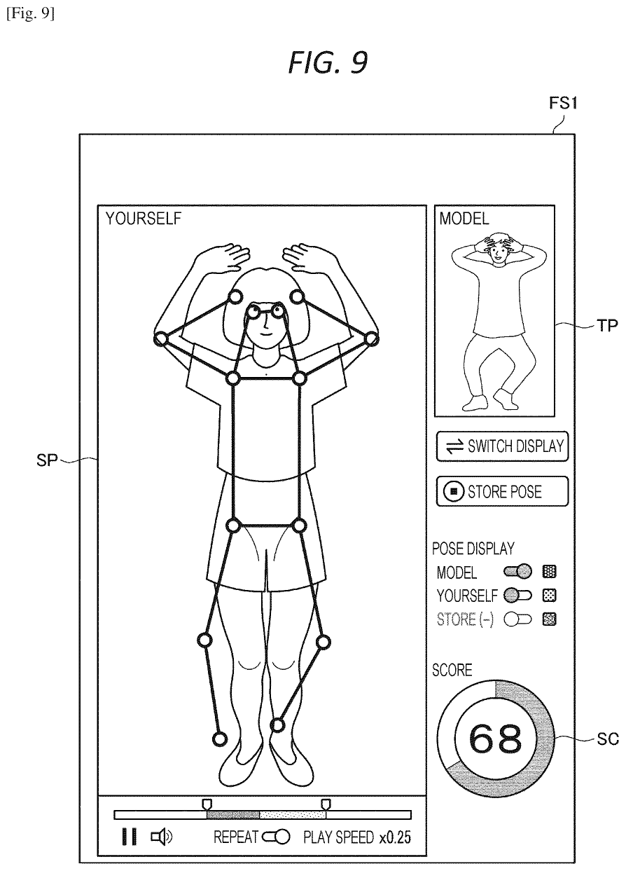

FIG. 9 is an explanatory diagram for describing a first feedback example according to an aspect of the present disclosure. The generation unit 155 may generate a superimposed screen SP in which reference skeleton data of the other user including reference bone converted according to the length of each portion of the user is superimposed on each portion of the user included in the motion video.

Then, the operation display unit 110 may display the feedback screen FS1 including the superimposed screen SP. For example, the generation unit 155 may generate the superimposed screen SP in which the model bone is superimposed on the bone at an arbitrary position by using the moment feature amount.

Specifically, the bone of the other user can be matched with the bone of the user by matching the parallel position with the center of gravity (x_{c}, y_{c}) and matching the scale with the length L of the bone. For example, the generation unit 155 may generate a reference bone (x^{b′}, y^{b′}) in which a bone (x^{b}, y^{b}) of the other user is superimposed on a bone (x^{a}, y^{a}) of the user by the following mathematical expressions (26) and (27).

$$[ Math . 26 ]$$

$${x}^{b ′} = ( {x}^{b} - {x}_{c}^{b} ) \cdot \frac{{L}^{a}}{{\dot{L}}^{b}} + {x}_{c}^{a} \qquad ( 26 )$$

$$[ Math . 27 ]$$

$${y}^{b ′} ( {y}^{b} - {y}_{c}^{b} ) \cdot \frac{{L}^{a}}{{L}^{b}} + {y}_{c}^{a} \qquad ( 27 )$$

Furthermore, the generation unit 155 may perform conversion with respect to rotation in addition to the position conversion of the bone with respect to the translation and scale described above. For example, the rotation amount can be calculated, based on a reference line whose position such as a line on the floor of the background is unchanged, on the basis of an angle θ from the reference line.

More specifically, the generation unit 155 may generate the reference bone (x^{b′}, y^{b′}) in which the bone (x^{b}, y^{b}) of the other user is superimposed on the bone (x^{a}, y^{a}) of the user by the following mathematical expressions (28) and (29).

$$[ Math . 28 ]$$

$${x}^{b ′} = ( {x}^{b} - {x}_{c}^{b} ) \cdot \frac{{L}^{a}}{{L}^{b}} cos θ - ( {y}^{b} - {y}_{c}^{b} ) \frac{{L}^{a}}{{L}^{b}} sin θ + {x}_{c}^{a} \qquad ( 28 )$$

$$[ Math . 29 ]$$

$${y}^{b ′} = ( {x}^{b} - {x}_{c}^{b} ) \cdot \frac{{L}^{a}}{{L}^{b}} sin θ + ( {y}^{b} - {y}_{c}^{b} ) \frac{{L}^{a}}{{L}^{b}} cos θ + {y}_{c}^{a} \qquad ( 29 )$$

By the method described above, the generation unit 155 may convert each bone of the other user into the reference bone to generate reference skeleton data. Then, the operation display unit 110 may display the feedback screen FS1 including the superimposed screen SP in which the reference skeleton data generated by the generation unit 155 is superimposed on the video of the user.

Note that the feedback screen FS1 may include information SC based on the similarity score s calculated by the calculation unit 153. The information SC based on the similarity score s may be, for example, a score value (0 to 100 points) obtained by multiplying the similarity score s by 100 as illustrated in FIG. 9, but the display screen according to an aspect of the present disclosure is not limited to such an example. For example, the information SC based on the similarity score s may be, for example, a graph which displays the similarity score s as a function of time. In this way, by expressing the similarity score as a function of time in a graph, the user can check the timeline of pose similarity and the portion in which the user needs to improve is easily recognized.

Furthermore, the feedback screen FS1 may include the model screen TP obtained by imaging the other user as a model. Here, the model screen TP may be a real-time video of the other user or a video based on image data obtained by imaging the other user in advance.

Furthermore, in the feedback screen FS1 illustrated in FIG. 9, the superimposed screen SP including the video of the user is displayed enlarged compared with the model screen TP, but the display screen according to an aspect of the present disclosure is not limited to such an example. For example, FIG. 9 illustrates the display screen. The positions of the superimposed screen SP and the model screen TP may be switched by an operation such as selecting a “display switching button”, or only one of the superimposed screen SP and the model screen TP may be displayed.

Furthermore, on the superimposed screen on screen SP, the skeleton data to be superimposed on the video of the user may be the skeleton data of the user instead of the skeleton data of the other user. The skeleton data to be superimposed on the video of the user may also be both the skeleton data of the user and the skeleton data of the other user. Such skeleton data to be superimposed on the superimposed screen may be switchable.

Furthermore, the feedback screen FS1 does not necessarily include the superimposed screen SP, and may include a video of the user instead of the superimposed screen SP.

Furthermore, the feedback screen FS1 may include a save button for saving an image of a pose, or may include a seek bar capable of changing a reproduction time.

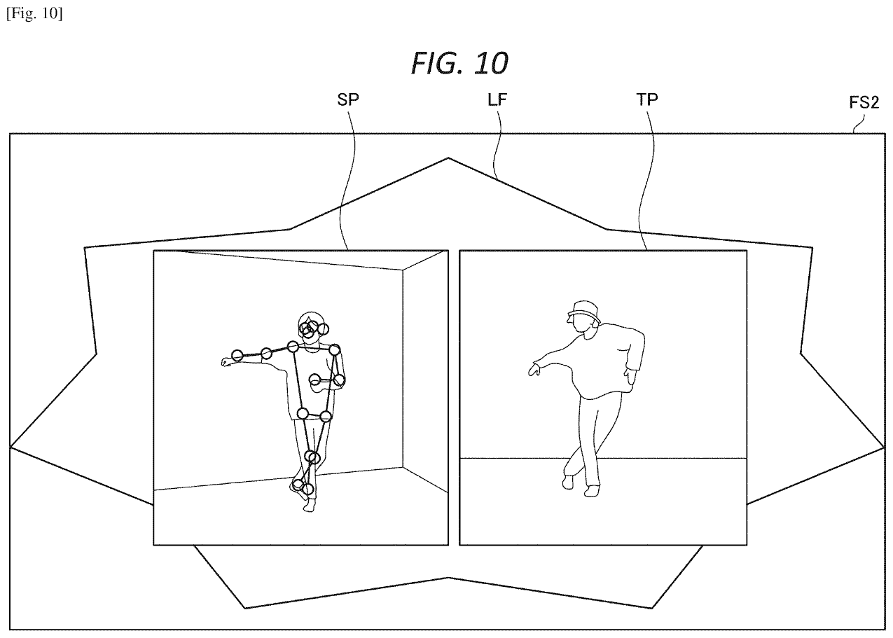

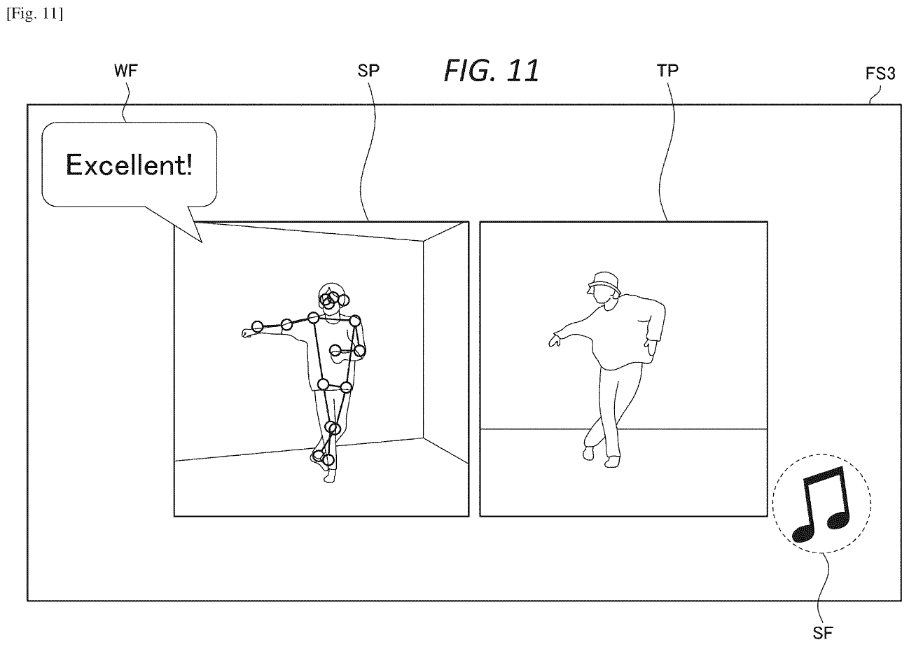

FIG. 10 is an explanatory diagram for describing a second feedback example according to an embodiment of the present disclosure. In the feedback screen FS2 illustrated in FIG. 10, the model screen TP is arranged on the right side, and the superimposed screen SP is arranged on the left side. Furthermore, the superimposed screen SP illustrated in FIG. 10 is a screen in which the skeleton data of the user is superimposed on the video of the user.

The generation unit 155 may generate color information LF as feedback information on the basis of the degree of similarity of poses of the plurality of users. Then, the operation display unit 110 may display the feedback screen FS2 including the color information LF generated by the generation unit 155 with the superimposed screen SP and the model screen TP.

For example, the generation unit 155 may generate color information that blinks in a frame in which the similarity score s is equal to or greater than the predetermined value. With this arrangement, when the screen blinks on the feedback screen FS2, the user can perceive that the pose of the user matches the model.

However, the color information does not necessarily need to be color information that blinks, and the generation unit 155 may generate color information corresponding to the similarity score s, for example. Specifically, the generation unit 155 may generate blue color information in a frame in which the similarity score s is equal to or greater than a first predetermined value, and generate red color information in a frame in which the similarity score is less than a second predetermined value. Here, the first predetermined value and the second predetermined value may be the same value, or the second predetermined value may be a value smaller than the first predetermined value. With this arrangement, the user can determine, one by one, a frame in which poses of the model and the user match, and a frame the poses do not match, and can intuitively grasp a pose to be more practiced.

Furthermore, the generation unit 155 may generate color information indicating the similarity of each bone on the basis of the magnitude of the degree of similarity D (or the similarity score s) for each bone of a plurality of users. More specifically, in a case where the degree of similarity of the upper body is calculated to be higher and the degree of similarity of the lower body is calculated to be lower, the generation unit 155 may generate the blue color information for the upper body bone of the skeleton data and generate the red color information for the lower body bone. Then, the operation display unit 110 may feedback the degree of similarity of poses for each portion to the user by changing a color of a portion (bone) where deviation in a pose occurs. In this way, by expressing the bone included in the skeleton data as a heat map, the user can intuitively understand in which portion particularly deviation occurs, and which pose should be corrected.

FIG. 10 is an explanatory diagram for describing a third feedback example according to an aspect of the present disclosure. The generation unit 155 may generate character information WF as feedback information on the basis of the degree of similarity of poses of the plurality of users.

For example, in a frame in which the similarity score s is equal to or greater than a first predetermined value, the generation unit 155 may generate a character information WF such as “Excellent!” that notifying the user that the poses match as illustrated in FIG. 10. On the other hand, in a frame in which the similarity score s is less than the second predetermined value, the generation unit 155 may generate a character information WF such as “Bad” that notifying the user that the poses do not match. Then, the operation display unit 110 may feedback a matching degree of the poses to the user by displaying the character information WF generated by the generation unit 155.

Furthermore, the generation unit 155 may generate sound information SF as feedback information on the basis of the degree of similarity of poses of the plurality of users.

For example, the generation unit 155 may generate the sound information SF that the poses match in a frame in which the similarity score s is equal to or greater than the first predetermined value. Then, the sound output unit 120 may feedback the matching degree of the poses to the user by outputting the sound information SF generated by the generation unit 155.

Note that, in the feedback presentation method illustrated in FIGS. 9 and 10, the superimposed screen SP is not necessarily included in the feedback screens FS2 and FS3, and the video of the user (that is, the video image that does not include the reference skeleton data) may be displayed instead of the superimposed screen SP.

The specific example of the feedback according to an aspect of the present disclosure has been described above.

### «4. Motion Processing Example»

The information processing system according to an aspect of the present disclosure has various application destinations. For example, the information processing system can be applied to a game in which a score is displayed by imitating a motion. Assuming such a game, for example, the user can play the game with imitating various motions in fitness, boxercise, yoga, dance, rehabilitation, or the like of the other user (character) on a screen. Furthermore, the information processing system can also be applied to a practice tool that assists improvement in motions in dance or the like. Assuming such a practice tool, the user may practice various motions in dance, ballet, golf, tennis, baseball, or the like. Furthermore, the information processing system can also be applied to an online lesson support tool. Assuming such a support tool, the user can take instructions on various motions in yoga, dance, rehabilitation, or the like from an instructor online.

Hereinafter, a specific example of motion processing of the information processing apparatus 10 according to an aspect of the present disclosure will be described on the assumption of such various application destinations.

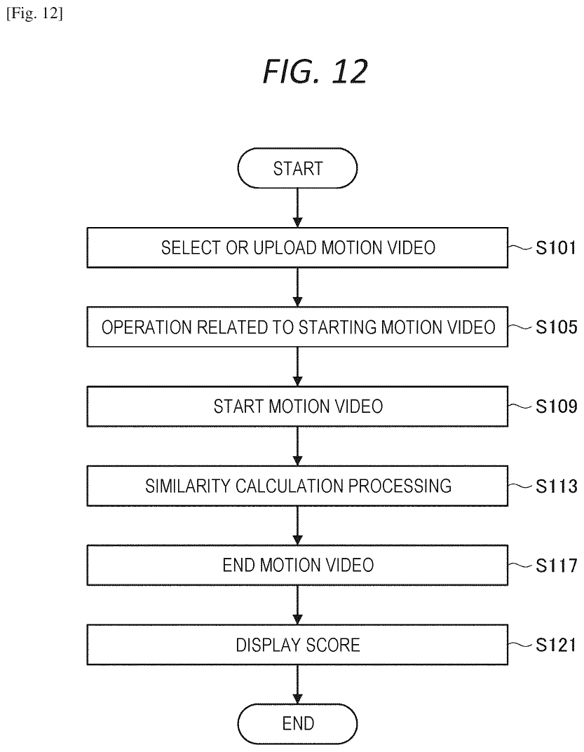

FIG. 12 is a flowchart illustrating a whole operation of the information processing apparatus 10 according to an aspect of the present disclosure. First, in the information processing apparatus 10, a motion video as a model is selected or uploaded by the user (step S101).

Furthermore, in the motion video as the model, a moment feature amount may be calculated in advance, or the moment feature amount may be calculated in real time. In a case where the moment feature amount is calculated in advance, the information processing apparatus 10 may perform time synchronization between the video of the user and the model motion video and read the moment feature amount of the model video at each time.

Subsequently, when receiving the operation related to starting the motion video from the user (step S105), the operation display unit 110 starts displaying the motion video (step S109). Here, the user starts a motion (for example, a dance or the like) in accordance with a pose in the motion video.

Next, the calculation unit 153 executes similarity calculation processing, which is various processing of calculating similarity on the basis of image data obtained by imaging the user and image data of the other user as a model (step S113). The similarity calculation processing will be described later.

Then, when the motion video ends (step S117), the operation display unit 110 displays a score (for example, a combined similarity score) (step S121) calculated by the calculation unit 153, and the information processing apparatus 10 according to an aspect of the present disclosure ends the motion processing.

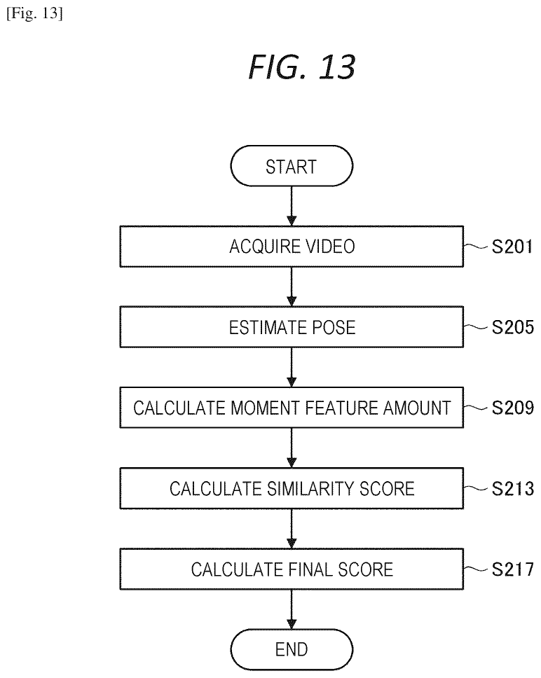

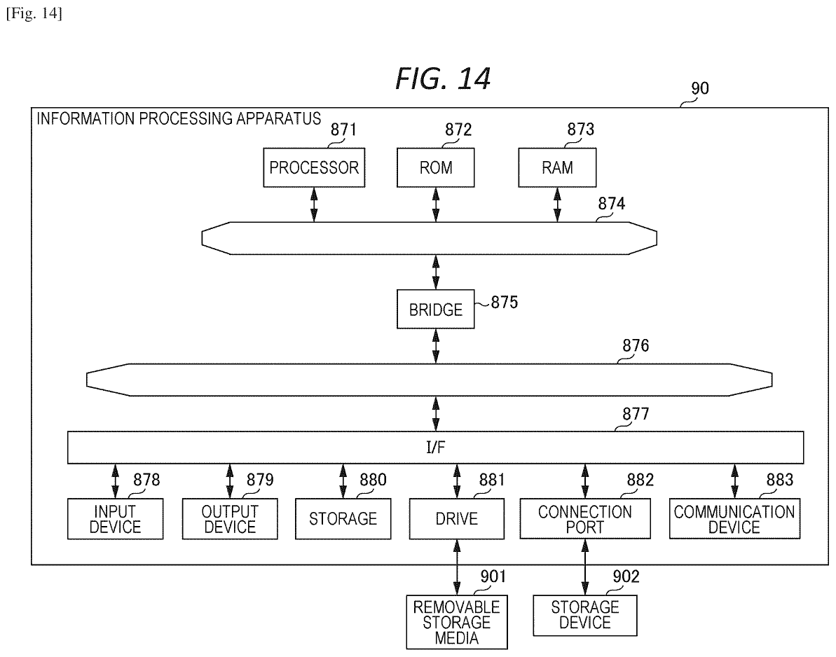

Next, details of the similarity calculation processing in step S113 will be described with reference to FIG. 13.

FIG. 13 is a flowchart illustrating similarity calculation processing of the information processing apparatus 10 according to an aspect of the present disclosure. First, the estimation unit 151 acquires image data showing the user (hereinafter referred to as user motion video) and image data showing the other user (hereinafter referred to as model motion video) (step S201).

Subsequently, the estimation unit 151 estimates a pose (skeleton data) of the user from the user motion video and estimates a pose (skeleton data) of the other user from the model motion video (step S205).

Then, the calculation unit 153 calculates each moment feature amount from each of the skeleton data of the user and the skeleton data of the other user (step S209).

Next, the calculation unit 153 calculates a similarity score on the basis of each moment feature amount (step S213). At this time, the calculation unit 153 sequentially outputs the similarity score calculated in each frame to the storage unit 140. Furthermore, the operation display unit 110 or the sound output unit 120 may output the feedback information based on the similarity score calculated in each frame one by one. However, the operation display unit 110 or the sound output unit 120 may output the feedback information of the similarity score in each frame, or may output the feedback information of the similarity score at intervals of several frames.

The processing in steps S201 to S213 described above is repeatedly performed until the user motion video and the model motion video are ended or the operation related to the end is executed by the user, the calculation unit 153 calculates the combined similarity score that is the average value of the similarity scores of the plurality of frames as a final score (step S217), and the information processing apparatus 10 according to an aspect of the present disclosure ends the motion processing.

Note that the motion processing described above is an example, and the motion processing of the information processing apparatus 10 according to an aspect of the present disclosure is not limited to such an example.

For example, in a case where the information processing system according to an aspect of the present disclosure is applied to a practice tool that assists improvement of motions in dance or the like, processing of reproducing a model motion video for the user to confirm, or processing of setting a reproduction range and a reproduction speed may be added between step S101 and step S105, or processing related to display of a lookback screen may be added after step S117 or step S121. The lookback screen may include various displays such as a comparison confirmation screen (including basic reproduction functions such as playing and rewinding) of the video of the user in the past and the model motion video, highlight display of a frame with low similarity, display that enables the user to confirm in which portion in the frame particularly deviation occurs, and the like. Furthermore, for such look-back, the storage unit 140 may record results of various types of processing such as user video, the skeleton data, the similarity, and the like.

Furthermore, in a case where the information processing system is applied to an online lesson support tool, selection and upload of a motion video by the user are unnecessary in step S101. In the above case, the information processing apparatus 10 of the user and the information processing apparatus 10 of the other user (model) may be connected to each other, and a session (lesson) may be started after adjustment of a position or the like of the camera is completed. The operation display unit 110 of each information processing apparatus 10 may display the video of the user and the video of the other user, and the sound output unit 120 may output sound acquired by a microphone on the user side and sound acquired by a microphone on the other user side. Furthermore, the information processing apparatus 10 may execute similarity calculation processing in real time during a session (lesson). At this time, feedback based on the similarity may be provided only to the information processing apparatus 10 of the user, or feedback based on the similarity may be provided to each of the information processing apparatus 10 of the user and the information processing apparatuses 10 of the other user. Furthermore, feedback may be performed in real time during the session, or feedback may be performed after the session.

### «5. Example of Action and Effect»

According to an aspect of the present disclosure described above, various actions and effects can be obtained. For example, the estimation unit according to an aspect of the present disclosure estimates skeleton data including position information of each portion of the user, and the calculation unit 153 calculates a normal central moment on the basis of lengths of two or more bones included in the skeleton data. With this arrangement, the pose similarity can be calculated without being affected by a difference in scale according to a position and posture at which the camera 5 is installed or deviation in the translation direction. Furthermore, since the calculation load is reduced compared with the machine learning, the limitation of the device is also reduced, and moreover, the pose similarity can be calculated in real time. By feeding back the similarity between the users in real time, the improvement of the motion of the user can be assisted.

Furthermore, the calculation unit 153 calculates Hu moment as a moment feature amount from the calculated normal central moment. With this arrangement, the pose similarity can be calculated without being further affected by positional deviation in the rotation direction in which the camera that has imaged the user is installed.

### «6. Hardware Configuration Example»

Next, a hardware configuration example of the information processing apparatus 10 according to an embodiment of the present disclosure will be described. FIG. 13 is a block diagram illustrating a hardware configuration example of an information processing apparatus 90 according to an embodiment of the present disclosure. The information processing apparatus 90 may be an apparatus having a hardware configuration equivalent to that of the information processing apparatus 10.

As illustrated in FIG. 13, the information processing apparatus 90 includes, for example, a processor 871, a read only memory (ROM) 872, a random access memory (RAM) 873, a host bus 874, a bridge 875, an external bus 876, an interface 877, an input device 878, an output device 879, a storage 880, a drive 881, a connection port 882, and a communication device 883. Note that the hardware configuration illustrated here is an example, and some of the components may be omitted. Furthermore, components other than the components illustrated here may be further included.

### (Processor 871)

The processor 871 functions as, for example, an arithmetic processing device or a control device, and controls the overall operation of each component or a part thereof on the basis of various programs recorded in the ROM 872, the RAM 873, the storage 880, or a removable storage medium 901.

### (ROM 872, RAM 873)

The ROM 872 is a unit that stores a program read by the processor 871, data used for calculation, and the like. The RAM 873 temporarily or permanently stores, for example, a program read by the processor 871, various parameters that appropriately change when the program is executed, and the like.

### (Host Bus 874, Bridge 875, External Bus 876, Interface 877)

The processor 871, the ROM 872, and the RAM 873 are mutually connected via, for example, the host bus 874 capable of high-speed data transmission. On the other hand, the host bus 874 is connected to the external bus 876 having a relatively low data transmission speed via the bridge 875, for example. Furthermore, the external bus 876 is connected to various components via the interface 877.

### (Input Device 878)

As the input device 878, a component such as a mouse, a keyboard, a touch panel, a button, a switch, a lever, and the like may be applied, for example. Moreover, as the input device 878, a remote controller (hereinafter referred to as remote) capable of transmitting a control signal using infrared rays or other radio waves may be used. Furthermore, the input device 878 includes a voice input device such as a microphone.

### (Output Device 879)

The output device 879 is a device capable of visually or audibly notifying the user of acquired information that is, for example, a display device such as a cathode ray tube (CRT), an LCD, and an organic EL, an audio output device such as a speaker and a headphone, a printer, a mobile phone, a facsimile, or the like. Furthermore, the output device 879 according to an embodiment of the present disclosure includes various vibration devices capable of outputting tactile stimulation.

### (Storage 880)

The storage 880 is a device for storing various kinds of data. As the storage 880, for example, there is used a magnetic storage device such as a hard disk drive (HDD), a semiconductor storage device, an optical storage device, a magneto-optical storage device, or the like.

### (Drive 881)

The drive 881 is, for example, a device that reads information recorded on the removable storage medium 901 such as a magnetic disk, an optical disk, a magneto-optical disk, or a semiconductor memory, or writes information on the removable storage medium 901.

### (Removable Storage Medium 901)

The removable storage medium 901 is, for example, a DVD medium, a Blu-ray (registered trademark) medium, an HD DVD medium, various semiconductor storage media, and the like. Of course, the removable storage medium 901 may be, for example, an IC card on which a non-contact IC chip is mounted, an electronic device, or the like.

### (Connection Port 882)

The connection port 882 is, for example, a port for connecting a storage device 902 such as a universal serial bus (USB) port, an IEEE1394 port, a small computer system interface (SCSI), an RS-232C port, or an optical audio terminal.

### (Storage Device 902)

The storage device 902 is an external connection device, for example, a printer, a portable music player, a digital camera, a digital video camera, an IC recorder, or the like.

### (Communication Device 883)

The communication device 883 is a communication device for connecting to a network, for example, a wired or wireless LAN, Bluetooth (registered trademark), or a communication card for Wireless USB (WUSB), a router for optical communication, a router for Asymmetric Digital Subscriber Line (ADSL), or a modem for various communications, or the like.

### «7. Supplement»

The embodiments of the present disclosure have been described in detail above with reference to the accompanying drawings, but the present disclosure is not limited to such examples. It is apparent that a person having ordinary knowledge in the technical field to which the present disclosure belongs can devise various change examples or modification examples within the scope of the technical idea described in the claims, and it will be naturally understood that they also belong to the technical scope of the present disclosure.

For example, in step S101 illustrated in FIG. 12, a plurality of motion videos may be selected or uploaded. For example, there is a case where, depending on dancers, the position or posture of a portion is different even in the same dance. Thus, in a case where a plurality of motion videos is selected or uploaded, feedback as to which dancer's dance the user's dance is similar to may be given to the user.

Furthermore, the operation display unit 110, the sound output unit 120, the storage unit 140, and the control unit 150 of the information processing apparatus 10 may be separately provided in different apparatuses. Furthermore, the estimation unit 151, the calculation unit 153, and the generation unit 155 that are included in the control unit 150 may be provided separately in a plurality of apparatuses.

Furthermore, although the example in which the skeleton data is estimated from the image data obtained by the camera 5 has been mainly described, for example, the estimation unit 151 may estimate the skeleton data of the user on the basis of sensing information obtained by a wearable motion sensor such as an inertial sensor and an acceleration sensor.

Furthermore, each step related to the processing of the information processing apparatus 10 of the present specification is not necessarily processed in time series in the order described in the flowchart. For example, each step in processing of the information processing apparatus 10 may be processed in an order different from the order described in a flowchart.

Furthermore, a computer program for causing hardware such as a CPU, a ROM, and a RAM built in the information processing apparatus 10 to exhibit functions equivalent to each configuration of the information processing apparatus 10 described above can also be created. Furthermore, a storage medium storing the computer program is also provided.

Furthermore, the effects described in the present specification are not restrictive. That is, the technique according to an aspect of the present disclosure can exhibit other effects apparent to those skilled in the art from the description of the present specification, in addition to the effect above or instead of the effect above.

Note that the present technology can be configured as follows.
(1) An information processing apparatus including:
circuitry configured to:
acquire model data;
acquire, based on a position and a posture of a user, data of a pose of the user;
estimate skeleton data including position information regarding portions of the user based on the position data; and
output a result of pose similarity based on the model data and the skeleton data,
wherein a same result of pose similarity is output based on different skeleton data that is estimated based on respective different position data of the pose of the user, the respective different position data being acquired from a first position and a first posture of the user, and from a second position and a second posture of the user, and
wherein at least one of the first position is different than the second position or the first posture is different than the second posture.
(2) The information processing apparatus according to 1,
wherein the portions of the user are less than an entire body of the user.
(3) The information processing apparatus according to any one of (1) or (2),
wherein the result of pose similarity is output based on a reliability score of the portions of the user.
(4) The information processing apparatus according to any one of (1) to (3),
wherein the result of pose similarity is output based on only portions of the user having the reliability score being greater than a predetermined value.
(5) The information processing apparatus according to any one of (1) to (4),
wherein moment feature amounts are calculated based on only the portions of the user having the reliability score being greater than the predetermined value, and
wherein the output of the result of pose similarity is based on the moment feature amounts.
(6) The information processing apparatus according to any one of (1) to (5),
wherein the circuitry is further configured to output a superimposed screen in which reference skeleton data of the model data is superimposed on the user.
(7) The information processing apparatus according to any one of (1) to (6),
wherein the circuitry is further configured to output a superimposed screen in which the skeleton data is superimposed on the user.
(8) The information processing apparatus according to any one of (1) to (7), wherein the circuitry is further configured to output color information by changing a color of a portion of the superimposed skeleton data based on a degree of similarity between the pose of the user corresponding to the portion of the skeleton data and the pose of the model data corresponding to the portion of the skeleton data being greater than a first predetermined value.
(9) The information processing apparatus according to any one of (1) to (8), wherein the circuitry is further configured to output second color information different than first color information by changing a color of another portion of the superimposed skeleton data based on the degree of similarity between the pose of the of the user corresponding to the portion of the skeleton data and the pose of the model data corresponding to the portion of the skeleton data being less than a second predetermined value.
(10) The information processing apparatus according to any one of (1) to (9), wherein the circuitry is further configured to output a superimposed screen in which reference skeleton data of the model data and the skeleton data are simultaneously superimposed on the user.
(11) The information processing apparatus according to any one of (1) to (10), wherein the result of pose similarity includes a similarity score representing a degree of similarity between the pose of the user and the pose of model data.
(12) The information processing apparatus according to any one of (1) to (11), wherein the result of pose similarity includes color information representing a degree of similarity between the pose of the user and the pose of model data.
(13) The information processing apparatus according to any one of (1) to (12), wherein the circuitry is further configured to output the color information based on the degree of similarity between the pose of the user and the pose of model data being greater than a predetermined value.
(14) The information processing apparatus according to any one of (1) to (13), wherein the circuitry is further configured to output first color information based on the degree of similarity between the pose of the user and the pose of model data being greater than a first predetermined value and output second color information different than the first color information based on the degree of similarity between the pose of the user and the pose of model data being less than a second predetermined value.
(15) The information processing apparatus according to any one of (1) to (14), wherein the first predetermined value is same as the second predetermined value.
(16) The information processing apparatus according to any one of (1) to (15), wherein the second predetermined value is less than the first predetermined value.
(17) The information processing apparatus according to any one of (1) to (16), wherein the result of pose similarity includes character information.
(18) The information processing apparatus according to any one of (1) to (17), wherein the result of pose similarity includes sound information.
(19) An information processing method including:
acquiring model data;
acquiring, based on a position and a posture of a user, data of a pose of the user;
estimating skeleton data including position information regarding portions of the user based on the position data; and
outputting a result of pose similarity based on the model data and the skeleton data, wherein a same result of pose similarity is output based on different skeleton data that is estimated based on respective different position data of the pose of the user, the respective different position data being acquired from a first position and a first posture of the user, and from a second position and a second posture of the user, and
wherein at least one of the first position is different than the second position or the first posture is different than the second posture.
(20) A non-transitory computer-readable medium having embodied thereon a program, which when executed by a computer causes the computer to function as execute an information processing method, the method including:
acquiring model data;
acquiring, based on a position and a posture of a user, data of a pose of the user;
estimating skeleton data including position information regarding portions of the user based on the position data; and
outputting a result of pose similarity based on the model data and the skeleton data, wherein a same result of pose similarity is output based on different skeleton data that is estimated based on respective different position data of the pose of the user, the respective different position data being acquired from a first position and a first posture of the user, and from a second position and a second posture of the user, and wherein at least one of the first position is different than the second position or the first posture is different than the second posture.
(B-1)
An information processing apparatus including:
an estimation unit that estimates skeleton data including position information regarding each portion of a user; and
a calculation unit that calculates a moment feature amount having at least scale invariance and translation invariance on the basis of lengths of two or more bones included in the skeleton data.
(B-2)
The information processing apparatus according to the above (B-1), in which
the calculation unit calculates a degree of similarity of poses of a plurality of the users on the basis of a plurality of moment feature amounts calculated from the respective pieces of the skeleton data of the plurality of users.
(B-3)
The information processing apparatus according to the above (B-2), in which
the calculation unit calculates a plurality of moment feature amounts on the basis of a length of each bone included in the respective pieces of the skeleton data of the plurality of users.
(B-4)
The information processing apparatus according to the above (B-3), in which the calculation unit calculates a degree of similarity of poses of the plurality of users for each of corresponding frames on the basis of the plurality of moment feature amounts calculated for each of the corresponding frames in a plurality of motion videos.
(B-5)
The information processing apparatus according to the above (B-4), in which the calculation unit calculates a combined similarity score on the basis of a plurality of degrees of similarity calculated in a plurality of corresponding frames.
(B-6)
The information processing apparatus according to the above (B-4) or (B-5), in which the moment feature amount includes seven or eight feature amounts having rotation invariance.
(B-7)
The information processing apparatus according to any one of the above (B-4) to
(B-6), further including
a generation unit that generates feedback information based on the degree of similarity of poses of the plurality of users.
(B-8)
The information processing apparatus according to the above (B-7), in which
the generation unit generates a superimposed screen in which reference skeleton data of another user including reference bone converted according to the length of each portion of the user is superimposed on each portion of the user included in the motion video.
(B-9)
The information processing apparatus according to any one of the above (B-2) to
(B-8), in which
the calculation unit calculates the moment feature amount on the basis of a reliability score estimated for each joint point at both ends of the bone.
(B-10)
The information processing apparatus according to the above (B-9), in which
the calculation unit calculates the moment feature amount on the basis of the length of the bone including the joint points estimated that the reliability score is equal to or greater than a predetermined value.
(B-11)
The information processing apparatus according to the above (B-9), in which
the calculation unit executes weighting processing based on the reliability scores of the joint points at both ends of the bone used for calculation of the respective moment feature amounts for each of the plurality of moment feature amounts, and calculates a degree of similarity of poses of the plurality of users on the basis of the plurality of moment feature amounts for which the weighting processing has been executed.
(B-12)
The information processing apparatus according to the above (B-11), in which
the calculation unit calculates the moment feature amount of a target frame on the basis of an average value of lengths of two or more bones included in the skeleton data of each frame in a predetermined period from the target frame.
(B-13)
The information processing apparatus according to the above (B-12), in which
the calculation unit calculates the moment feature amount on the basis of lengths of corrected bones obtained by calibration processing of correcting the lengths of the bones of the plurality of users.
(B-14)
The information processing apparatus according to the above (B-7), in which
the generation unit generates color information as the feedback information on the basis of the degree of similarity of poses of the plurality of users.
(B-15)
The information processing apparatus according to the above (B-14), in which
the generation unit generates color information indicating similarity of each bone on the basis of magnitude of a degree of similarity for each bone of the plurality of users.
(B-16)
The information processing apparatus according to the above (B-7), in which
the generation unit generates character information as the feedback information on the basis of the degree of similarity of poses of the plurality of users.
(B-17)
The information processing apparatus according to the above (B-7), in which
the generation unit generates sound information as the feedback information on the basis of the degree of similarity of poses of the plurality of users.
(B-18)
The information processing apparatus according to the above (B-7) or (B-8), further including
an output unit that outputs the feedback information and superimposed screen information generated by the generation unit.
(B-19)
An information processing method that is executed by a computer, the information processing method including:
estimating skeleton data including position information regarding each portion of a user; and
calculating a moment feature amount having at least scale invariance and translation invariance on the basis of lengths of two or more bones included in the skeleton data.
(B-20)
A program that causes a computer to implement:
an estimation function that estimates skeleton data including position information regarding each portion of a user; and
a calculation function that calculates a moment feature amount having at least scale invariance and translation invariance on the basis of lengths of two or more bones included in the skeleton data.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

5 Camera
10 Information processing apparatus
110 Operation display unit
120 Sound output unit
130 Communication unit
140 Storage unit
150 Control unit
151 Estimation unit
153 Calculation unit
155 Generation unit

1. An information processing apparatus comprising:
circuitry configured to:
acquire model data;
acquire, based on a position and a posture of a user, data of a pose of the user;
estimate skeleton data including position information regarding portions of the user based on the position data; and
output a result of pose similarity based on the model data and the skeleton data,
wherein a same result of pose similarity is output based on different skeleton data that is estimated based on respective different position data of the pose of the user, the respective different position data being acquired from a first position and a first posture of the user, and from a second position and a second posture of the user, and
wherein at least one of the first position is different than the second position or the first posture is different than the second posture.

2. The information processing apparatus according to claim 1,
wherein the portions of the user are less than an entire body of the user.

3. The information processing apparatus according to claim 1,
wherein the result of pose similarity is output based on a reliability score of the portions of the user.

4. The information processing apparatus according to claim 3,
wherein the result of pose similarity is output based on only portions of the user having the reliability score being greater than a predetermined value.

5. The information processing apparatus according to claim 4,
wherein moment feature amounts are calculated based on only the portions of the user having the reliability score being greater than the predetermined value, and
wherein the output of the result of pose similarity is based on the moment feature amounts.

6. The information processing apparatus according to claim 1,
wherein the circuitry is further configured to output a superimposed screen in which reference skeleton data of the model data is superimposed on the user.

7. The information processing apparatus according to claim 1,
wherein the circuitry is further configured to output a superimposed screen in which the skeleton data is superimposed on the user.

8. The information processing apparatus according to claim 7, wherein the circuitry is further configured to output color information by changing a color of a portion of the superimposed skeleton data based on a degree of similarity between the pose of the user corresponding to the portion of the skeleton data and the pose of the model data corresponding to the portion of the skeleton data being greater than a first predetermined value.

9. The information processing apparatus according to claim 8, wherein the circuitry is further configured to output second color information different than first color information by changing a color of another portion of the superimposed skeleton data based on the degree of similarity between the pose of the of the user corresponding to the portion of the skeleton data and the pose of the model data corresponding to the portion of the skeleton data being less than a second predetermined value.

10. The information processing apparatus according to claim 1,
wherein the circuitry is further configured to output a superimposed screen in which reference skeleton data of the model data and the skeleton data are simultaneously superimposed on the user.

11. The information processing apparatus according to claim 1,
wherein the result of pose similarity includes a similarity score representing a degree of similarity between the pose of the user and the pose of model data.

12. The information processing apparatus according to claim 1,
wherein the result of pose similarity includes color information representing a degree of similarity between the pose of the user and the pose of model data.

13. The information processing apparatus according to claim 12,
wherein the circuitry is further configured to output the color information based on the degree of similarity between the pose of the user and the pose of model data being greater than a predetermined value.

14. The information processing apparatus according to claim 12,
wherein the circuitry is further configured to output first color information based on the degree of similarity between the pose of the user and the pose of model data being greater than a first predetermined value and output second color information different than the first color information based on the degree of similarity between the pose of the user and the pose of model data being less than a second predetermined value.

15. The information processing apparatus according to claim 14, wherein the first predetermined value is same as the second predetermined value.

16. The information processing apparatus according to claim 14, wherein the second predetermined value is less than the first predetermined value.

17. The information processing apparatus according to claim 1,
wherein the result of pose similarity includes character information.

18. The information processing apparatus according to claim 1,
wherein the result of pose similarity includes sound information.

19. An information processing method comprising:
acquiring model data;
acquiring, based on a position and a posture of a user, data of a pose of the user;
estimating skeleton data including position information regarding portions of the user based on the position data; and
outputting a result of pose similarity based on the model data and the skeleton data,
wherein a same result of pose similarity is output based on different skeleton data that is estimated based on respective different position data of the pose of the user, the respective different position data being acquired from a first position and a first posture of the user, and from a second position and a second posture of the user, and
wherein at least one of the first position is different than the second position or the first posture is different than the second posture.

20. A non-transitory computer-readable medium having embodied thereon a program, which when executed by a computer causes the computer to function as execute an information processing method, the method comprising:
acquiring model data;
acquiring, based on a position and a posture of a user, data of a pose of the user;
estimating skeleton data including position information regarding portions of the user based on the position data; and
outputting a result of pose similarity based on the model data and the skeleton data,
wherein a same result of pose similarity is output based on different skeleton data that is estimated based on respective different position data of the pose of the user, the respective different position data being acquired from a first position and a first posture of the user, and from a second position and a second posture of the user, and
wherein at least one of the first position is different than the second position or the first posture is different than the second posture.
